(19) United States
(12) Patent Application Publication
(10) Pub. No.: US 2008/0123060 A1
(43) Pub. Date: May 29, 2008

(54) ADJUSTMENT METHOD FOR AN IMAGE PROJECTION DISPLAY DEVICE AND AN IMAGE PROJECTION DISPLAY DEVICE

(75) Inventor: Shohei MATSUOKA, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/770,864

(22) Filed: Jun. 29, 2007

(30) Foreign Application Priority Data
Jun. 30, 2006 (JP) 2006-181228
Jun. 30, 2006 (JP) 2006-181255

(51) Int. Cl. G03B 21/14

(52) U.S. Cl. 353/79

(57) ABSTRACT

An adjustment method for an image-projection display device, in which an image-projection optical unit, a flat screen, and a mirror are provided, and with the method, a bundle of light rays emitted from the image-projection optical unit is bent by the mirror so that a principal light ray, of a bundle of light rays being incident on the center of the flat screen, is made incident on the flat screen at an oblique angle; and the adjustment method comprising steps of,

moving one of the image-projection optical unit in the direction orthogonal to the flat screen and the mirror in at least a direction parallel to the flat screen or a direction orthogonal to the flat screen; and

moving the other of the image-projection optical unit in the direction orthogonal to the flat screen and the mirror in at least a direction parallel to the flat screen or a direction orthogonal to the flat screen;

whereby the position of an image on the flat screen is adjusted without varying a projection distance between the image-projection optical unit and the flat screen.

### BACKGROUND OF THE INVENTION

1. Field of the Invention

The present invention relates to an image-projection display device (rear projection television), and in particular, relates to an adjustment method for adjusting an image on a display screen of the image-projection display device in an assembly process thereof.

2. Description of the Prior Art

An image-projection display device (rear projection television) projects a bundle of image-carrying light rays emitted from an image-projection optical unit onto a screen to be viewed as an image. For the purpose of miniaturizing an image-projection display device, and of reducing the size thereof in the optical axis direction (thinning), a bundle of image-carrying light rays emitted from the image-projection optical unit is bent by reflection so that the bundle of light rays is made incident on the screen at an oblique angle (not a right angle). In the present patent application, this type of projection is defined as an oblique-projection by which the principal light ray of a bundle of light rays incident on the center of the flat screen 12 is incident thereon at an oblique angle (not a right angle).

In such an image-projection display device of an oblique-projection type, an up-to-down positional adjustment of the image on the screen is carried out at the time of assembly by the following sequence:

(i) the image-projection optical unit itself is moved horizontally in a direction orthogonal to the screen; and

(ii) the image projection optical unit is moved up and down in a direction parallel to the screen in order to correct the change (focal shift) in the projection distance (optical path) between the image-projection optical unit and the screen due to the above horizontal movement orthogonal to the screen.

As can be seen in the above sequence, in the case of the above image-projection display device of an oblique-projection type which is devised for prioritizing miniaturization, the horizontal movement of the image projection optical unit has to be linked with the up-to-down movement thereof.

However, the image-projection optical unit has a certain amount of weight, so that it is mechanically difficult to move the image projection optical unit in an up-to-down direction. Moreover, errors in traveling distances of the image-projection optical unit would possibly occur in the above movements of the image-projection optical unit in both an orthogonal (horizontal) and an up-to-down (parallel) directions with respect to the screen.

Still further, since other adjustments (e.g., focal adjustment (projection distance adjustment)) are also required, the conventional image-projection optical unit has to be movably supported in both horizontal and vertical directions.

### SUMMARY OF THE INVENTION

The present invention is to provide an adjustment method for an image-projection display device, by which an image position adjustment (up-to-down position adjustment) on the screen can be performed without moving the image-projection optical unit in the up-to-down direction and without varying the projection distance (optical path) between the image-projection optical unit and the screen.

The present invention is devised on the following confirmed by the inventor:

By coordinating (i) a step of moving an image-projection optical unit in the direction orthogonal to the screen, and (ii) a step of moving a mirror for reflecting a bundle of image-carrying light rays emitted from the image-projection optical unit in at least a direction parallel to the screen or a direction orthogonal to the screen, an image position adjustment (up-to-down position adjustment) on the screen can be performed even in a rear projection television of an oblique-projection type, without varying the projection distance (optical path) between the image-projection optical unit and the screen.

According to an aspect of the present invention, there is provided an adjustment method for an image-projection display device.

The image-projection display device includes an image-projection optical unit, a flat screen, and a mirror.

With the method, a bundle of light rays emitted from the image-projection optical unit is bent by the mirror so that a principal light ray, of a bundle of light rays being incident on the center of the flat screen, is made incident on the flat screen at an oblique angle.

The adjustment method includes steps of,
moving one of the image-projection optical unit in the direction orthogonal to the flat screen and the mirror in at least a direction parallel to the flat screen or a direction orthogonal to the flat screen; and
moving the other of the image-projection optical unit in the direction orthogonal to the flat screen and the mirror in at least a direction parallel to the flat screen or a direction orthogonal to the flat screen;
whereby the position of an image on the flat screen is adjusted without varying a projection distance between the image-projection optical unit and the flat screen.

The image-projection optical unit and the mirror are preferably to move in a direction orthogonal to the flat screen according to the ratio of condition (1) to condition (2) with respect to traveling distances of the image-projection optical unit and the mirror:

((1+sin(ω+2γ)/sin ω)/tan θ)−(1/tan ω)−(cos(ω+2γ)/sin ω) (1)

((1+sin(ω+2γ)/sin ω)/tan θ)−(cos(ω+2γ)/sin ω)+(1/tan β) (2)

wherein

β(°) designates the angle between the mirror and a normal on the flat screen;

ω(°) designates an angle between the principal light ray of the bundle of light rays that runs from the image-projection optical unit to the mirror and the normal on the flat screen, the principal light ray of which is to be incident on the center of the flat screen at an oblique angle;

φ(°) designates an angle between the principal light ray and the normal on the flat screen;

γ(°) designates an angle defined as 90° −ω−β; and

θ(°) designates an angle defined as 90°−ω−2β+φ

The image-projection optical unit is preferably moved in the direction orthogonal to the flat screen, and the mirror is moved in the direction parallel to the flat screen so that the ratio of condition (1) to condition (3) with respect to traveling distances of the image-projection optical unit and the mirror is satisfied:

((1+sin(ω+2γ)/sin ω)/tan θ)−(1/tan ω)−(cos(ω+2γ)/sin ω) (1)

[((1+sin(ω+2γ)/sin ω)/tan θ)−(cos(ω+2γ)/sin ω)+(1/tan β)tan β (3)

wherein

β(°) designates the angle between the mirror and a normal on the flat screen;

ω(°) designates an angle between the principal light ray of the bundle of light rays that runs from the image-projection optical unit to the mirror and the normal on the flat screen, the principal light ray of which is arranged to be incident on the center of the flat screen at an oblique angle;

φ(°) designates an angle between the principal light ray and the normal on the flat screen;

γ(°) designates an angle defined as 90°−ω−β; and

θ(°) designates an angle defined as 90°−ω−2β+φ

The image-projection display device further includes a fixed mirror between the mirror and the flat screen so that the fixed mirror reflects the bundle of light rays reflected by the mirror toward the flat screen.

According to an aspect of the present invention, there is provided an image-projection display device including an image-projection optical unit, a flat screen, a first mirror which is closest to the image-projection optical unit, a second mirror which is closet to the flat screen.

The first mirror and the second mirror are arranged so that a principal light ray of a bundle of light rays, emitted from the image-projection optical unit and being incident on the center of the flat screen, is made incident on the flat screen at an oblique angle.

An angle β formed by a reflection surface of the first mirror and a normal on the flat screen, and an angle α formed by a reflection surface of the second mirror and a normal on the flat screen are approximately set as β=2α.

The first mirror is movable so that the reflection surface of the first mirror before being moved and the reflection surface thereof after being moved are parallel to each other.

When an angle θ1 between the principal light ray and the flat screen is defined, the following condition is preferably satisfied:

2α−2.8 sin θ1≦β≦2α+2.8 sin θ1

When an angle φ between the principal light ray and a normal on the flat screen is defined, the following condition is preferably satisfied:

α=φ/2

According to a further aspect of the present invention, there is provided an adjustment method for an image-projection display device.

The image-projection display device includes an image-projection optical unit, a flat screen, a first mirror which is closest to the image-projection optical unit, a second mirror which is closet to the flat screen are provided.

With the method, the first mirror and the second mirror are arranged so that a principal light ray, of a bundle of light rays emitted from the image-projection optical unit and being incident on the center of the flat screen, is made incident on the flat screen at an oblique angle.

The adjustment method including steps of,

setting an angle β formed by a reflection surface of the first mirror and a normal on the flat screen two times as large as an angle α formed by a reflection surface of the second mirror and a normal on the flat screen; and

adjusting the up-to-down position of an image on the flat screen, without varying the projection length between the image-projection optical unit and the flat screen, by moving the first mirror in a direction toward or away from the flat screen so that the reflection surface of the first mirror before being moved and the reflection surface thereof after being moved are parallel to each other.

When an angle θ1 between the principal light ray and the flat screen is defined, the following condition is preferably satisfied;

2α−2.8 sin θ1≦β≦2α+2.8 sin θ1

When an angle φ between the principal light ray and a normal on the flat screen is defined, the following condition is preferably satisfied;

α=φ/2

The present disclosure relates to subject matter contained in Japanese Patent Application Nos. 2006-181228 and 2006-181255 (both filed on Jun. 30, 2006) which are expressly incorporated herein in their entireties.

### BRIEF DESCRIPTION OF THE DRAWINGS

The present invention will be discussed below in detail with reference to the accompanying drawings, in which:

FIG. 1 is a conceptual view showing a method of an image-position adjustment on the screens for an oblique-projection type image-projection display device (rear projection television), according to a first embodiment of the present invention;

FIG. 2 is a conceptual view illustrating the principle of the image-position adjustment on the screen, according to the first embodiment of the present invention;

FIG. 3 is the partially enlarged view of FIG. 2;

FIG. 4 is a conceptual view showing a method of an image-position adjustment on the screen, for an oblique-projection type image-projection display device (rear projection television), according to a second embodiment of the present invention;

FIG. 5 is a conceptual view illustrating the principle of the image-position adjustment on the screen, according to the second embodiment of the present invention;

FIG. 6 is a conceptual view for explaining the principle in FIG. 5 by indicating the triangle ΔCC′D′ and the inverted triangle ΔAA′B which are overlapped; and

FIG. 7 is a conceptual view showing a method of an image-position adjustment on the screen, for an oblique-projection type image-projection display device (rear projection television), according to a third embodiment of the present invention.

### DESCRIPTION OF THE EMBODIMENTS

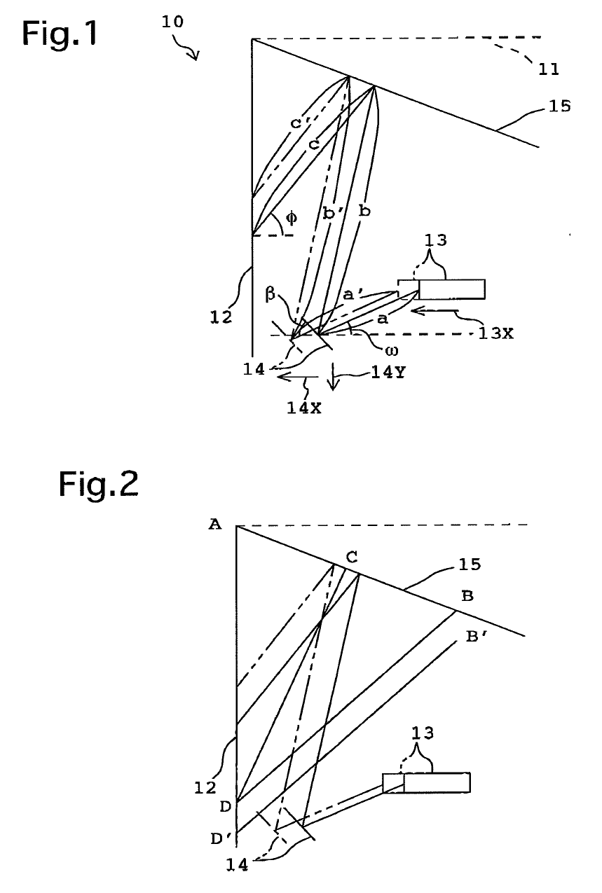

FIG. 1 is the conceptual view showing a method of an image-position adjustment on the screen, for an oblique-projection type image-projection display device (rear projection television), to be carried out during assembly thereof, according to the first embodiment of the present invention.

The image-projection display device 10 is provided with, in a body 11 thereof, a flat screen 12 on a side of the body 11, an image-projection optical unit (image engine) 13, a small mirror 14 (a mirror) which is closest to the image-projection optical unit 13, and a fixed mirror 15 which is closest to the flat screen 12.

A bundle of image-carrying light rays (hereinafter, a bundle of light rays) emitted from the image-projection optical unit 13 is reflected by the small mirror 14. Thereafter, the bundle of light rays is incident on the fixed mirror 15, and is reflected toward the flat screen 12. Finally, the bundle of light rays is incident on the flat screen 12 at an oblique angle.

A plurality of mirrors (i.e., more than two mirrors) may be provided between the image-projection optical unit 13 and the flat screen 12; however, it is essential that the bundle of light rays be incident on the flat screen 12 at an oblique angle; and it is specifically essential that the principal light ray of a bundle of light rays being incident on the center of the flat screen 12 is inclined at a predetermined angle.

In the above described image-projection display device 10, the image-position adjustment on the screen is performed by moving the image-projection optical unit 13 in a direction 13X orthogonal to the flat screen 12, and moving the small mirror 14 either in a direction 14X orthogonal to the flat screen 12, or in a direction 14Y parallel to the flat screen 12. The above movements of the small mirror 14 are performed so that the reflection surface of the small mirror 14 before being moved (before adjustment) and the reflection surface thereof after being moved (after adjustment) are parallel to each other.

The traveling distance of the image-projection optical unit 13 and that of the small mirror 14 with respect to the flat screen 12 and the fixed mirror 15 are set to maintain the following condition (ratio):

a+b+c=a′+b′+c′

wherein

a designates the optical path length from the image-projection optical unit 13 to the small mirror 14 before adjustment;

a′ designates the optical path length from the image-projection optical unit 13 to the small mirror 14 after adjustment;

b designates the optical path length from the small mirror 14 to the fixed mirror 15 before adjustment;

b′ designates the optical path length from the small mirror 14 to the fixed mirror 15 after adjustment;

c designates the optical path length from the fixed mirror 15 to the flat screen 12 before adjustment; and

c′ designates the optical path length from the fixed mirror 15 to the flat screen 12 after adjustment.

By appropriately setting the ratio of the traveling distances of the (movable) image-projection optical unit 13 to those of the (movable) small mirror 14 with respect to the (immovable) fixed mirror 15 and the (immovable) flat screen 12, the position of the image on the flat screen 12 (i.e., the up-to-down position of the principal light rays of the bundle of image-carrying light rays) can be adjusted without varying the optical paths length from the image-projection optical unit 13 to the flat screen 12.

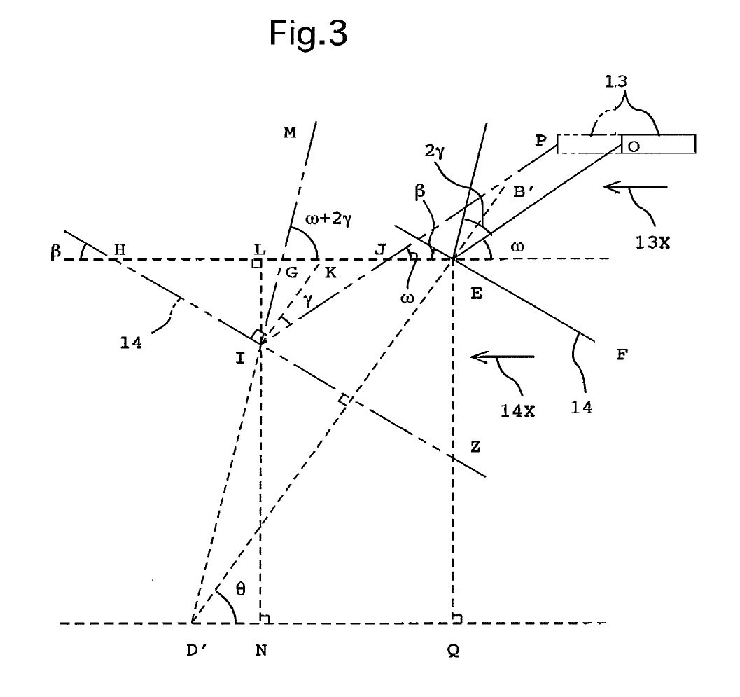

FIG. 2 is the conceptual view illustrating the principle of the image-position adjustment on the screen, according to the first embodiment of the present invention. FIG. 3 is the partially enlarged view of FIG. 2.

In FIGS. 2 and 3, the positions of the image-projection optical unit 13 and the small mirror 14 before adjustment are shown as solid lines, and the positions thereof after adjustment are shown as two-dot chain lines.

In FIG. 2, on the fixed mirror 15, a normal CD is depicted at the center between the incident points of the (solid lines) principal light ray and the (the two-dot chain lines) principal light ray; and, the point A where the fixed mirror 15 and the flat screen 12 meet is determined, Then, the line-symmetrical point B on the fixed mirror 15 with respect to the normal CD is determined; thereby, the optical path length (solid line) within a triangle ABD (hereinafter, ΔABD) before adjustment and the optical path length (two-dot chain line) within ΔABD after adjustment become equal.

Likewise, in the case where a line B′D′ which is parallel to the lines BD is depicted, the optical path length from the flat screen 12 to the line B′D′ before and after adjustment are also becomes equal.

FIG. 3, which is the partially enlarged view of FIG. 2, illustrates the case where the line B′D′ passes through a point E on the small mirror 14 before adjustment.

As explained, according to FIG. 2, the optical path length (two-dot chain line) from the flat screen 12 to the point D′ after adjustment is equal to the optical path length (solid line) from the flat screen 12 to point E (before adjustment).

Here, the optical path length after adjustment is reflected at a point I on the small mirror 14. Consequently, the optical path length after adjustment actually becomes shorter by the length of the line ID′.

Furthermore, with respect to the optical path length from the image-projection optical unit 13 to the small mirror 14, the optical path length before adjustment is the length of the line segment OE, whereas the optical path length after adjustment is the length of the line segment PI.

As can bee seen from FIG. 3, Line Segment PI=Line Segment OE+Line Segment JI; therefore, when ID′=IJ, the optical path lengths before and after adjustment become equal.

According to FIGS. 1 to 3, variables are defined as follows to determine the lengths of JI, ID′, IN, LN, ND′, ED′, QD′, LH, JH and GL:

β(∠GHI (°)) designates the angle between the small mirror 14 and the normal on the flat screen 12;

ω(∠PJE(°)) designates an angle between the principal light ray of the bundle of light rays that runs from the image-projection optical unit 13 to the small mirror 14 and the normal on the flat screen 12, the principal light ray of which is to be incident on the center of the flat screen 12 at an oblique angle.

φ(°) (FIGS. 1, 4 and 7) designates an angle between the above principal light ray and the normal on the flat screen 12.

γ(∠KIJ(°)) designates an angle between the above principal light ray and the normal on the small mirror 14, and defined as 90°−ω−β; and

θ(∠ED′Q(°))=90°−ω−2β+φ.

Here, the length of line LI is normalized as 1; the line JI=1/sin ω; JI=ID′; and the line ID′=1/sin ω.

Then, the lengths of the lien segments are as follows:
Line Segment ID′=1/sin ω;
Line Segment IN=sin(ω+2γ)/sin ω;
Line Segment LN=1+sin(ω+2γ)/sin ω;
Line Segment ND′=cos(ω+2γ)/sin ω;
Line Segment ED′=(1+sin(ω+2γ)/sin ω)/sin θ;
Line Segment QD′=(1+sin(ω+2γ)/sin ω)/tan θ;
Line Segment LH=1/tan β;
Line Segment JL=1/tan ω; and
Line Segment GL=1/tan(ω+2γ).

In order to achieve ID′±IJ, the following positional conditions (1) and (2) have to be satisfied;

the traveling distance EJ of the image-projection optical unit 13 in the direction 13X orthogonal to the flat screen 12 before and after adjustment is defined as follows:

EJ=QD′−JL−ND′=((1+sin(ω+2γ)/sin ω)/tan θ)−(1/tan ω)−(cos(ω+2γ)/sin ω) (1)

the traveling distance EH of the small mirror 14 in the direction 14X orthogonal to the flat screen 12 before and after adjustment is defined as follows:

EH=QD′−ND′+LH=((1+sin(ω+2γ)/sin ω)/tan θ)−(cos(ω+2γ)/sin ω)+(1/tan β) (2)

Furthermore, the traveling distance ED′ of the image on the flat screen 12 for adjustment in the up-to-down direction is as follows:

ED′=(1+sin(ω+2γ)/sin ω)/sin θ (2′)

Namely, the up-to-down position of the image on the flat screen 12 can be adjusted without varying the optical path length from the image-projection optical unit 13 to the flat screen 12, provided that the image-projection optical unit 13 and the small mirror 14 are moved in the direction orthogonal to the flat screen 12 while the ratio of condition (1) to condition (2) is satisfied as follows:

EJ:EH=((1+sin(ω+2γ)/sin ω)/tan θ)−(1/tan ω)−(cos(ω+2γ)/sin ω):((1+sin(ω+2γ)/sin ω)/tan θ)−(cos(ω+2γ)/sin ω)+(1/tan β)

As an alternative, the small mirror 14 can be moved in the direction 14Y (FIG. 1) parallel to the flat screen 12, instead of moving the small mirror 14 in the direction 14X.

More specifically, moving the small mirror 14 in the direction 14X by a unit-distance of “1” is the equivalent to moving the small mirror 14 in the direction 14Y by “1/tan β”. Accordingly, the traveling distance EZ (FIG. 3) of the small mirror 14 in the direction 14Y is obtained by a fourth condition:

HL:LI=HE:EZ HL;1=HE:EZ EZ=HE/HL=HE/(1/tan γ)=EH tan β=[((1+sin(ω+2γ)/sin ω)/tan ω)−(cos(ω+2γ)/sin ω)+(1/tan β)]tan β (3)

The distance between the image-projection optical unit 13 and the flat screen 12 can be adjusted without varying the up-to-down position the image on the flat screen 12 by moving the image-projection optical unit 13 in the direction 13X orthogonal to the flat screen 12, and by moving the small mirror 14 in the direction 14Y parallel to the flat screen 12 so that the ratio of condition (1) to condition (3) is satisfied as follows;

EJ:EZ=((1+sin(ω+2γ)/sin ω)/tan θ)−(1/tan ω)−(cos(ω+2γ)/sin ω): tan β[((1+sin(ω+2γ)/sin ω)/tan θ)−(cos((ω+2γ)/sin ω)+(1/tan β)]

According to the first embodiment, examples illustrating the adjustment of the up-to-down position of the image on the flat screen 12,the traveling distance of the image-projection optical unit 13, and that of the small mirror 14 are hereinafter discussed.

In regard the directions 13X and 14X, moving toward the flat screen 12 is indicated as “+” (positive); and in regard to the direction 14Y, moving downward is indicated as “+” (positive).

For the adjustment according to the first embodiment, it is possible to move the image-projection optical unit 13 and the small mirror 14, in this order or a reversed order. Namely, the image-projection optical unit 13 and the small mirror 14 can be moved in any order. Further, it is also possible to move the image-projection optical unit 13 and the small mirror 14 simultaneously.

For moving the image-projection optical unit 13 and the small mirror 14, linear movement mechanisms, which are known in the art, can be used. For example, a feed-screw mechanism can be employed, in which the image-projection optical unit 13 and the small mirror 14 can be moved with the above-described ratios by controlling the rotational angle of the feed-screw of the feed-screw mechanism.

### EXAMPLE 1

The angles are set as follows:
φ=52.30°;
ω=22.30°;
β=38.00°;and
γ=29.70°.

With the above angles, the traveling distances are determined as follows:

the traveling distance of the image on the flat screen 12 for adjustment in the up-to-down direction=10.00 mm;

the traveling distance of the image-projection optical unit 13 in the direction 13X=1.77 mm; and

the traveling distance of the small mirror 14 in the direction 14X=8.93 mm.

### EXAMPLE 2

Under the same condition of Embodiment 1, the small mirror 14 is moved in the direction parallel to the flat screen 12.

The angles are set as follows;
φ=52.30°;
ω=22.30°;
β=38.00°; and
γ=29.70°.

With the above angles, the traveling distances are determined as follows:

the traveling distance of the image on the flat screen 12 for adjustment in the up-to-down direction=10.00 mm;

the traveling distance of the image-projection optical unit 13 in the direction 13X=1.77 mm; and

the traveling distance of the small mirror 14 in the direction 14Y=6.97 mm

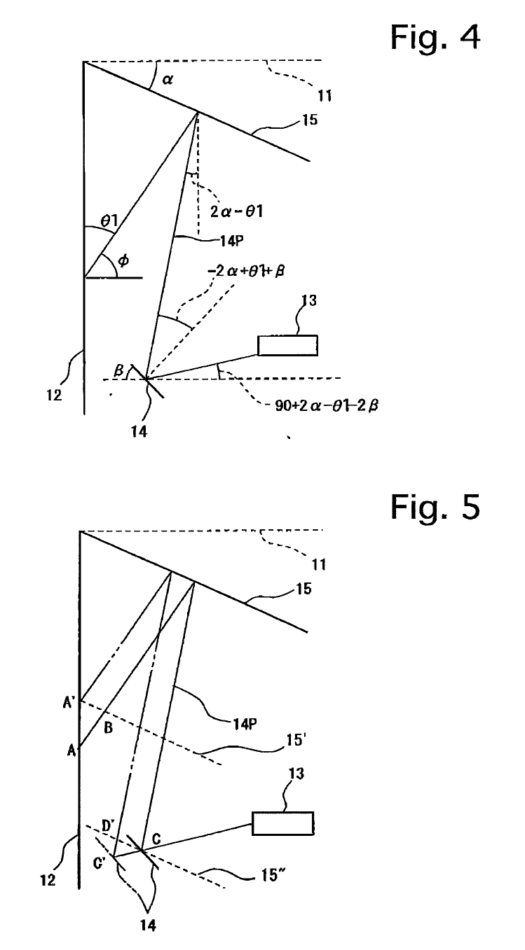

FIG. 4 is the conceptual view showing a method of an image-position adjustment on the screen, for an oblique-projection type image-projection display device (rear projection television) 10, according to the second embodiment of the present invention.

FIG. 5 is the conceptual view illustrating the principle of the image-position adjustment on the screen, according to the second embodiment of the present invention.

The image-projection display device 10 is provided with, in a body 11 thereof, a flat screen 12 on a side of the body 11, an image-projection optical unit (image engine) 13, a small mirror 14 (a first mirror) which is closest to the image-projection optical unit 13, and a fixed mirror 15 (a second mirror) which is closest to the flat screen 12.

A bundle of light rays emitted from the image-projection optical unit 13 is reflected by the small mirror 14. Thereafter, the bundle of light rays is incident on the fixed mirror 15, and is reflected toward the flat screen 12. Finally, the bundle of light rays is incident on the flat screen 12 at an oblique angle.

A plurality of mirrors (i.e., more than two mirrors) may be provided between the image-projection optical unit 13 and the flat screen 12; however, it is essential that the bundle of light rays be incident on the flat screen 12 at an oblique angle; and it is specifically essential that the principal light ray of a bundle of light rays being incident on the center of the flat screen 12 is inclined at a predetermined angle.

In the image-projection display device 10 of the second embodiment, an angle between the fixed mirror 15 and the normal on the flat screen 12 is defined as an angle α. Then, the angle β is defined as β≈2α, while β=2α is most preferable. As shown in FIG. 4, in the case where the angles α and β are defined, the up-to-down position of the image on the flat screen 12 can be adjusted, without varying the projection length between the image-projection optical unit 13 and the flat screen 12, by moving the small mirror 14 in a direction toward or away from the flat screen 12 so that the reflection surface of the small mirror 14 before being moved (before adjustment) and the reflection surface thereof after being moved (after adjustment) are parallel to each other.

In FIG. 5, the position of the small mirror 14 before adjustment is shown as solid line, and the position thereof after adjustment is shown as two-dot chain line.

Parallel line segments 15′ and 15″ are depicted from an incident point A′ on the flat screen 12 after adjustment and an incident point C on the small mirror 14 before adjustment. When the optical path length AB before adjustment is equal to the optical paths length CC′+C′D′ after adjustment (i.e., AB=CC′+C′D′), the up-to-down position of the image on the flat screen 12 can be adjusted without varying the projection length between the image-projection optical unit 13 and the flat screen 12.

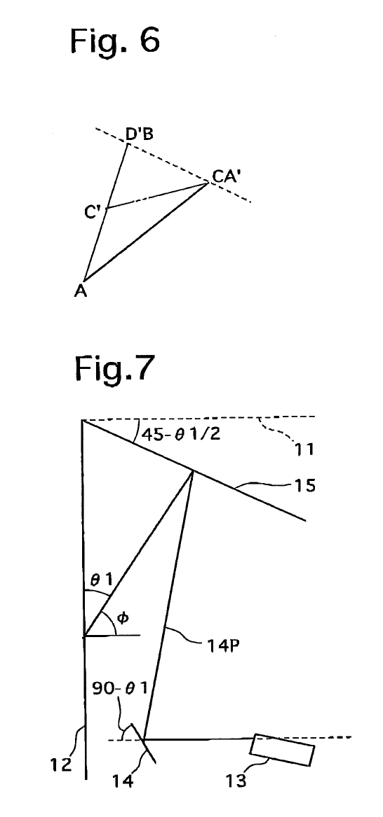

FIG. 6 is the conceptual view for explaining the principle in FIG. 5 by indicating the triangle ΔCC′D′ and the inverted triangle ΔAA′B which are overlapped.

It is confirmed that AB=AC′+C′D′.

In order to satisfy this condition, it is necessary that AC′ be equal to CC′ (AC′=CC′).

∠CC′D′=2θ1;

wherein θ1 designates the angle between the principal light ray of the bundle of light rays incident on the center of flat screen 12 and the flat screen 12.

Here, 2θ1=2(−2α+θ1+β).

Then, β=2α

Therefore when β=2α is satisfied, the up-to-down position of the image on the flat screen 12 can be adjusted by moving the small mirror 14 in the direction along the bundle of light rays emitted from the image-projection optical unit 13 to the small mirror 14 (as shown in FIG. 5), without varying the projection length between the image-projection optical unit 13 and the flat screen 12.

The above β=2α is a geometrically ideal condition. If the value of β deviates from the ideal value by, e.g., the amount of Δ(°), the amount of focal shift (FS) (i.e., the amount of change in optical path length of the principal light ray of the bundle of light rays toward center of the flat screen 12) is considered to be a product of the amount of adjustment of the up-to-down position of the image on the flat screen 12 (AJM) and sin θ1/tan(θ1+Δ):

FS AJM×sin θ1/tan(θ1+Δ)

This equation can be rearranged as follows:

FS=AJM×δ/sin θ1=AJM×Δ×(3.14/180)/sin θ1

Here, note that δ is the value by which Δ is expressed in radians.

If a focal shift occurs, the change in the image-forming magnification on the flat screen 12, which is approximately the same as the amount of the focal shift (FS), occurs. Even if the change in the image-forming magnification on the flat screen 12 occurs, in the case where the amount of the change in the image-forming magnification on the flat screen 12 is within 5% of the amount on the up-to-down adjustment, the change in the image-forming magnification on the flat screen 12 is not visually noticeable:

AJM×Δ×(3.14/180)sin θ1<0.05

More practically, when the following condition is satisfied, the up-to-down position of the image on the flat screen 12 can be adjusted without causing visually noticeable focal shift:

2α−2.8 sin θ≦β≦2α+2.8 sin θ (4)

For moving the small mirror 14 according to the second embodiment, linear movement mechanisms, which are known in the art, can be used. For example, a feed-screw mechanism can be employed, in which the small mirror 14 can be by controlling the rotational angle of the feed-screw of the feed-screw mechanism.

FIG. 7 is the conceptual view illustrating a further method for the image-position adjustment in an image-projection display device, according to the third embodiment of the present invention.

Here, it should be understood that the third embodiment is a particular solution of the second embodiment. Therefore due to the third embodiment, the up-to-down position of the image on the flat screen 12 can also be adjusted by moving the small mirror 14 or the image-projection optical unit 13 in the direction orthogonal to the flat screen 12 without varying the projection distance between the flat screen 12 and the image-projection optical unit 13.

More specifically, the third embodiment (FIG. 7) is arranged to satisfy the following condition;

α=φ/2 (5)

If condition (5) is satisfied, the small mirror 14 can be moved in the direction orthogonal to the flat screen 12.

Namely, θ1 (°) is defined as an angle between the principal light ray of a bundle of light rays being incident on the center of the flat screen 12 and the flat screen 12; and, as previously defined, φ (°) designates an angle between the above principal light ray and the normal on the flat screen 12.

Then, the angle between the small mirror 14 and the normal on the flat screen 12 is set to be β=90°−θ1, and, α is set to be 45°−θ1/2; then,

90+2α−θ1−2β=0

φ=90−θ1, and

hence α=φ/2(β−α=φ/2)

According to the third embodiment, the up-to-down position of the image on the flat screen 12 can be adjusted by moving the small mirror 14 in a direction orthogonal to the flat screen 12, and the projection length from the image-projection optical unit 13 to the flat screen 12 can be adjusted by moving the image-projection optical unit 13 in the direction orthogonal to the flat screen 12, without varying the up-to-down position of the image on the flat screen 12.

For the adjustment according to the third embodiment, it is possible to move the image-projection optical unit 13 and the small mirror 14, in this order or a reversed order. Namely, the image-projection optical unit 13 and the small mirror 14 can be moved in any order. Further, it is also possible to move the image-projection optical unit 13 and the small mirror 14 simultaneously.

For moving the image-projection optical unit 13 and the small mirror 14, linear movement mechanisms, which are known in the art, can be used. For example, a feed-screw mechanism can be employed, in which the image-projection optical unit 13 and the small mirror 14 can be moved with the above-described ratios by controlling the rotational angle of the feed-screw of the feed-screw mechanism.

According to the second and third embodiments, examples illustrating the adjustment of the up-to-down position of the image on the flat screen 12, and the traveling distance of the small mirror 14 are hereinafter discussed.

In regard the directions of the small mirror 14, moving downward the flat screen is indicated as “+” (positive).

### EXAMPLE 3

The angles are set as follows:
α=20°
β=40°
θ1=37°
90+2α−θ−2β (angle between the optical axis of the image-projection optical unit 13 and the normal on the flat screen 12)=13°

With the above angles, the traveling distances are determined as follows:

The traveling distance of the small mirror 14 in the direction along the bundle of light rays emitted from the image-projection optical unit 13 to the small mirror 14(as shown in FIG. 5) to the flat screen 12=7.78 mm; and

the traveling distance of the image on the flat screen 12 for adjustment in the up-to-down direction=10.00 mm.

### EXAMPLE 4

The angles are set as follows;
α=25°
β=51.5°
θ1=40°(φ=50°)

With the above angles, the traveling distances are determined as follows:

The traveling distance of the small mirror 14 in the direction orthogonal to the flat screen 12=6.18 mm; and

the traveling distance of the image on the flat screen 12 for adjustment in the up-to-down direction=10.00 mm; and

the amount of focal shift (FS)=−0.42 mm.

In Example 4, the angle β is set to β=2α+1.5; and β≦2α±2.8 sin 40°=2α±1.8 is satisfied.

At the same time, α=φ/2 is satisfied.

The amount of focal shift (FS) occurred in this example is −0.42 mm, which is less than 5% of the amount of the up-to-down adjustment (10 mm) of the image on the flat screen 12. Consequently, the focal shift is not visually noticeable, and practically negligible to the extent that the image-projection display device 10 appears to maintain sufficient accuracy.

Linear movement mechanisms, which are known in the art, can be used as the mechanisms for moving the image-projection optical unit 13 and the small mirror 14. For example, a feed-screw mechanism can be employed, in which the image projection optical unit 13 and the small mirror 14 can be linearly moved in a more accurate manner by controlling the rotational angle of the feed-screw of the feed-screw mechanism.

According to the above descriptions, in an image-projection display device having an oblique-projection type image-projection optical unit, by moving the image-projection optical unit 13 by a predetermined distance in the direction orthogonal to the flat screen 12 and the small mirror 14 by a predetermined distance in at least a direction parallel to the flat screen 12 or a direction orthogonal to the flat screen 12, the position of an image on the flat screen 12, in an assembling process, can be adjusted without varying a projection distance between the image-projection optical unit 13 and the flat screen 12.

Furthermore, according to the above descriptions, in an image-projection display device including an image-projection optical unit 13, a flat screen 12, the first mirror 14 and the second mirror for bending a bundle of light rays emitted from the image-projection optical unit 13 toward the flat screen 12 so that the bundle of light rays is incident on the flat screen 12 at an oblique angle by determining angles of the first mirror 14 and the second mirror 15 with respect to the flat screen 12, the position of an image on the flat screen 12, in an assembling process, can be adjusted only by moving the first mirror 14.

Obvious changes may be made in the specific embodiments of the present invention described herein, such modifications being within the spirit and scope of the invention claimed. It is indicated that all matter contained herein is illustrative and does not limit the scope of the present invention.

What is claimed is:

1. An adjustment method for an image-projection display device, in which an image-projection optical unit, a flat screen, and a mirror are provided, and with said method, a bundle of light rays emitted from said image-projection optical unit is bent by said mirror so that a principal light ray of a bundle of light rays being incident on the center of said flat screen, is made incident on said flat screen at an oblique angle; and
said adjustment method comprising steps of,
moving one of said image-projection optical unit in
the
direction orthogonal to said flat screen and said mirror in at least a direction parallel to said flat screen or a direction orthogonal to said flat screen; and
moving the other of said image-projection optical unit in the direction orthogonal to said flat screen and said mirror in at least a direction parallel to said flat screen or a direction orthogonal to said flat screen;
whereby the position of an image on said flat screen is adjusted without varying a projection distance between said image-projection optical unit and said flat screen.

2. The adjustment method for an image-projection display device according to claim 1, wherein said image-projection optical unit and said mirror are arranged to move in a direction orthogonal to said flat screen according to the ratio of condition (1) to condition (2) with respect to traveling distances of said image-projection optical unit and said mirror:
((1+sin(ω+2γ)/sin ω)/tan θ)−(1/tan ω)−(cos(ω+2γ)/sin ω) (1)
((1+sin(ω+2γ)/sin ω)/tan θ)−(cos(ω+2γ)/sin ω)+(1/tan β) (2)
wherein
β(°) designates the angle between said mirror and a normal on said flat screen;
ω(°) designates an angle between said principal light ray of said bundle of light rays that runs from said image-projection optical unit to said mirror and the normal on said flat screens said principal light ray of which is to be incident on the center of said flat screen at an oblique angle;
φ(°) designates an angle between said principal light ray and the normal on said flat screen;
γ(°) designates an angle defined as 90°−ω−β; and
θ(°) designates an angle defined as 90°−ω−2β+φ.

3. The adjustment method for an image-projection display device according to claim 1, wherein said image-projection optical unit is moved in the direction orthogonal to said flat screen, and said mirror is moved in the direction parallel to said flat screen so that the ratio of condition (1) to condition (3) with respect to traveling distances of said image-projection optical unit and said mirror is satisfied:
((1+sin(ω+2γ)/sin ω)/tan θ)−(1/tan ω)−(cos(ω+2γ)/sin ω) (1)
[((1+sin(ω+2γ)/sin ω)/tan θ)−(cos(ω+2γ)/sin ω)+(1/tan β)]tan β (3)
wherein
β(°) designates the angle between said mirror and a normal on said flat screen;
ω(°) designates an angle between said principal light ray of said bundle of light rays that runs from said image-projection optical unit to said mirror and the normal on said flat screen, said principal light ray of which is arranged to be incident on the center of said flat screen at an oblique angle;
φ(°) designates an angle between said principal light ray and the normal on said flat screen;
γ(°) designates an angle defined as 90°−ω−β; and
θ(°) designates an angle defined as 90°−ω−2β+φ.

4. The adjustment method for an image-projection display device according to claim 1, wherein said image-projection display device further comprises a fixed mirror between said mirror and said flat screen so that said fixed mirror reflects the bundle of light rays reflected by said mirror toward said flat screen.

5. An image-projection display device comprising an image-projection optical unit, a flat screen, a first mirror that is closest to said image-projection optical unit, a second mirror that is closet to said flat screen,
wherein said first mirror and said second mirror are arranged so that a principal light ray of a bundle of light rays, emitted from said image-projection optical unit and being incident on the center of said flat screen, is made incident on said flat screen at an oblique angle;
wherein an angle β formed by a reflection surface of said first mirror and a normal on said flat screen, and an, angle α formed by a reflection surface of said second mirror and a normal on said flat screen are approximately set as β=2α; and
wherein said first mirror is movable so that said reflection surface of said first mirror before being moved and said reflection surface thereof after being moved are parallel to each other.

6. The image-projection display device according to claim 5, wherein when an angle θ1 between said principal light ray and said flat screen is defined, the following condition is satisfied:
2α−2.8 sin θ1≦β≦2α+2.8 sin θ1.

7. The image-projection display device according to claim 5, wherein when an angle φ between said principal light ray and a normal on said flat screen is defined, the following condition is satisfied:
α=φ/2

8. An adjustment method for an image-projection display device, in which an image-projection optical unit, a flat screen, a first mirror that is closest to said image-projection optical unit, a second mirror that is closet to said flat screen are provided, wherein said first mirror and said second mirror are arranged so that a principal light ray of a bundle of light rays, emitted from said image-projection optical unit and being incident on the center of said flat screen is made incident on said flat screen at an oblique angle;
said adjustment method comprising steps of,
setting an angles β formed by a reflection surface of said first mirror and a normal on said flat screen two times as large as an angle α formed by a reflection surface of said second mirror and a normal on said flat screen; and
adjusting the up-to-down position of an image on said flat screen, without varying the projection length between said image-projection optical unit and said flat screen, by moving said first mirror in a direction toward or away from said flat screen so that said reflection surface of said first mirror before being moved and said reflection surface thereof after being moved are parallel to each other.

9. The adjusting method an image-projection display device according to claim 8, wherein when an angle θ1 between said principal light ray and said flat screen is defined, the following condition is satisfied;
2α−2.8 sin θ1≦β≦2α+2.8 sin θ1.

10. The adjusting method an image-projection display device according to claim 8, wherein when an angle θ between said principal light ray and a normal on said flat screen is defined, the following condition is satisfied:
α=θ/2.
